(19) United States
(12) Patent Application Publication
(10) Pub. No.: US 2011/0099037 A1
(43) Pub. Date: Apr. 28, 2011

(54) Location-Based, Time Sensitive Wireless Exchange

(75) Inventors: Brian E. Levin, Englewood, CO (US); Christopher Glodé, Denver, CO (US)

(73) Assignee: USEFUL NETWORKS, INC., Denver, CO (US)

(21) Appl. No.: 12/606,943

(22) Filed: Oct. 27, 2009

(51) Int. Cl. G06Q 30/00; G06Q 50/00; G01C 21/00; G01C 21/34

(52) U.S. Cl. 705/5; 701/213; 701/209; 705/26.41

(57) ABSTRACT

A peer-to-peer, proximity based, open marketplace for buyers and sellers of event tickets permits subscribers to use a buyer-seller exchange service via a clearinghouse server to connect with other users to coordinate the sale of tickets and other time sensitive items based on factors such as asking price, availability of tickets, market activity, as well as the physical proximity of the buyer and seller.

### TECHNICAL FIELD

The present invention relates generally to methods and systems for locating wireless devices, also called mobile stations (MS), such as those used in analog or digital cellular systems, personal communications systems (PCS), enhanced specialized mobile radios (ESMRs), and other types of wireless communications systems. More particularly, but not exclusively, the present invention relates to a system and method for a peer-to-peer, location proximity-based, open marketplace for buyers and sellers of time sensitive wares.

### BACKGROUND

Prior to 1991, use of the Internet for business was prohibited and only informal buying and selling occurred, mainly in the various USENET newsgroups which were a continuation of the earlier electronic bulletin boards system (BBS). In the mid and late 1990's, the spread of personal computers, high speed modems, and the wired Internet made electronic Commerce (E-Commerce) possible for the general public. E-commerce, the online transaction of business via computers and computer networks, took many forms including business-to-consumer, business-to-business and consumer-to-consumer (also called peer-to-peer).

The United States Federal Communications Commission (FCC) as part of the Enhanced 9-1-1 (E9-1-1) Phase II mandate, required wireless carriers to locate callers for Emergency Services (9-1-1, 1-1-2, etc). Carriers were allowed to deploy either network-based or handset-based location technologies. Deployment started in October 2001 and has generally continued to the present time. As a result of the E9-1-1 Phase II laws and regulations, location-based services using high-accuracy, Phase II compliant location techniques are now accessible to the majority of wireless users via the wireless carrier's networks.

Location of mobile phones is also possible via third party providers. Dual mode WiFi-cellular phones allow the use of surveyed WiFi (IEEE 802.11) access points to be used for rough localization. HDTV receiver equipped mobile phones allow for localization using HDTV broadcasts with uploaded assistance data. Mapping of carrier cell sites allows for rough location using the broadcast information and uploaded cell-location data. Manual inputting of postal (zip code) or address information may also be used for rough localization.

Over the same time period, mobile telephone technology has experienced significant improvements in one-way and duplex data transmission speeds and display capabilities. Also referred to as “smartphones,” common subscriber models include advanced text, voice, on-board processing and memory capabilities that support mobile commerce (also known as M-commerce). The proliferation of these advanced mobile phones has blurred the lines between personal computer and mobile devices as well as wireless data systems and the Internet.

Using such advanced capabilities of the mobile phone wireless networks that provide seamless connectivity, a variety of peer-to-peer M-Commerce applications have been developed. One such M-Commerce application is the peer-to-peer ticket exchange, sometimes called fan-to-fan ticketing, wherein users can post ticket and price information to a web site for examination and purchase by other users. Not a true peer-to-peer application, the peer-to-peer ticket exchange relies on an intermediary (e.g., the web site owner) to register both buyers and sellers as well as to store, list, and categorize tickets. The intermediary may also provide secondary databased information such as seller rankings to further assist buyers.

Use of a clearinghouse to supply location-based services to subscribers or between subscribers across multiple wireless carriers was foreseen in 2006. Further background information regarding such a clearinghouse may be found in U.S. application Ser. No. 11/857,173, filed on Sep. 18, 2007. It would be advantageous to provide a clearinghouse application that can coordinate the locations of buyers and sellers using multiple location technologies and both user and control location planes.

### SUMMARY

Disclosed herein is a buyer-seller exchange application that facilitates a location-enabled peer-to-peer electronic marketplace for the sale and resale of event tickets (these can be physical, or electronic). Since tickets to shows, concerts, sporting or other events are both time and location sensitive, use of this application allows both the buyer and seller assurance that tickets are available and that a purchase is eminent.

The buyer-seller exchange application supports both primary and secondary market players allowing an electronic channel for primary vendors and distribution via secondary market vendors. Ticket vendors and buyers may have profiles and rating and ranking factors linked to persistent pseudonyms, thus allowing both buyers and sellers to remain anonymous until the actual transaction (or longer in cases where a third party intermediary is used).

Secondary market resale is a form of arbitrage auction in which tickets sold through secondary sources sell for less or more than their face value depending on demand, which itself tends to vary as the event date approaches. The buyer-seller exchange application, by allowing users access to a listing service of available or needed events, venues, and tickets, enables a new mobile electronic arbitrage with the assurance that the ticket buyer and seller are in close proximity so that the sale may be completed with minimal latency. Listings may be sorted by distance to the buyer using near real-time location techniques, and users may send messages to each other anonymously through the arbitrage system to avoid revealing their identity until they decide to complete a transaction. The buyer-seller exchange application may also provide secondary databased information such as detailed area maps to further assist buyers in finding sellers. The clearinghouse provided by the buyer-seller exchange application thus has the advantage of being able to coordinate the locations of buyer and seller regardless of the location technique or technology or the location plane used to develop the location.

### BRIEF DESCRIPTION OF THE DRAWINGS

The foregoing summary as well as the following detailed description are better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 schematically depicts an illustrative embodiment of the present invention, including components, interfaces, and external dependencies.

FIG. 2 schematically depicts an illustrative embodiment of a clearinghouse in accordance with the present invention.

FIG. 3A shows exemplary clearinghouse interconnections to a GSM carrier, where the clearinghouse acts as a 3GPP defined Gateway Mobile Location Center (GMLC) and LCS Client in multiple wireless networks.

FIG. 3B shows exemplary clearinghouse interconnections to a UMTS carrier, where the clearinghouse acts as a 3GPP defined GMLC and LCS Client in multiple wireless networks.

FIG. 3C shows exemplary clearinghouse interconnections to a CDMA2000 carrier, where the clearinghouse acts as both a 3GPP2-defined Network LCS Client and an External LCS Client in multiple wireless networks.

FIG. 3D shows the clearinghouse implemented in a Generic Access Network (GAN).

FIG. 4 shows steps employed for user service provisioning using the clearinghouse via a 3rd party storefront.

FIG. 5 shows steps employed for execution of a subscriber-specific location based service (LBS), in this example a mobile application used to locate another mobile device.

FIG. 6 depicts the procedure for the clearinghouse to supply anonymous location information to a 3rd party based on user privacy settings and the requested area.

FIG. 7 depicts a clearinghouse supplying access to service subscribed mobile location based on user privacy settings and a clearinghouse LBS data auction application.

FIG. 8 illustrates a clearinghouse used as a datamining facility into allowed and/or anonymous location information stored by the clearinghouse.

FIG. 9 depicts a clearinghouse supplying access to service subscribed mobile location based on user privacy settings and a clearinghouse LBS data auction application for location-enhanced secondary ticket exchange.

FIGS. 10a through 10c depict some exemplary events and transactions describing embodiments of the buyer-seller exchange application.

FIG. 11 depicts an exemplary process incorporating some of the embodiments disclosed herein.

### DETAILED DESCRIPTION OF ILLUSTRATIVE EMBODIMENTS

Wireless subscribers currently are limited by radio access technology, wireless location technology, and wireless carrier implementation of location-based services. In a notable example, wireless subscribers roaming from one operator's geographic coverage area may not be able to access location-based services available in the subscriber's home area or home carrier. This issue is compounded by the implementation of multiple access techniques (such as dual mode WiFi and GSM or CDMA mobile phones) and mobile-virtual-network-operators (MVNOs) with targeted subscriber service offerings. The embodiments described herein can be used to provide wireless subscribers with access to the high quality location-based services experience while at the same time providing such wireless subscribers a uniform level of privacy and security.

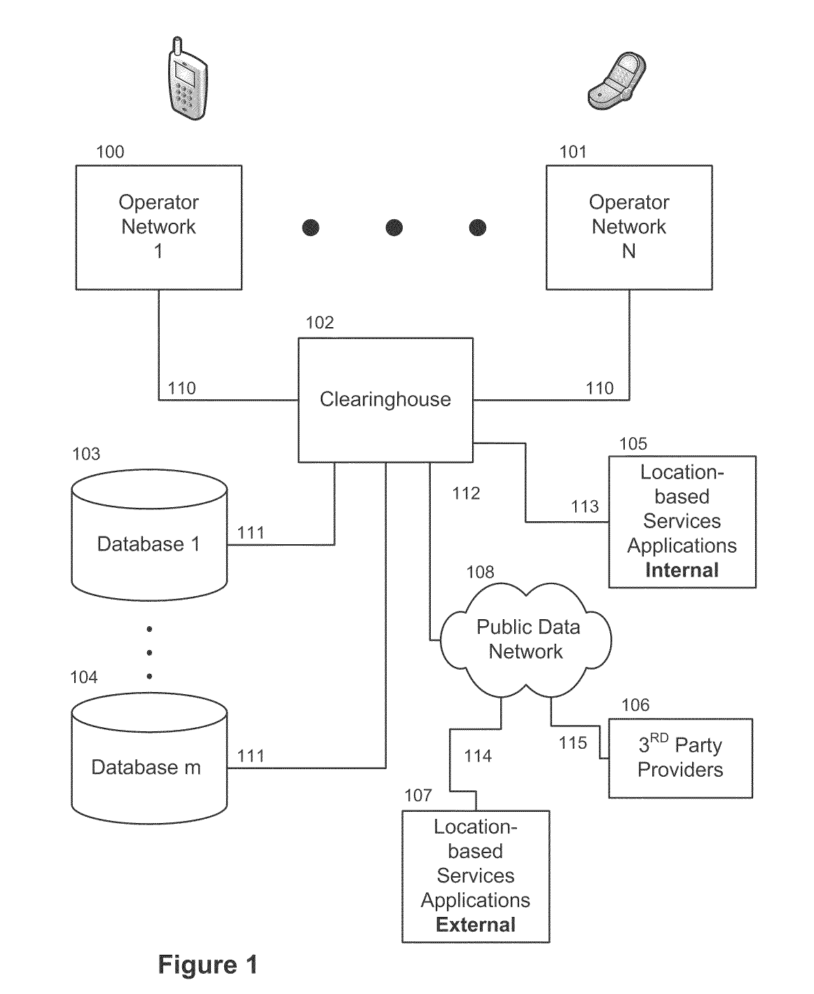

Referring to FIG. 1, in an exemplary embodiment, the wireless carriers' networks (100 and 101) may be bridged by a Clearinghouse (102). In one embodiment, Clearinghouse (102) may be configured to provision subscriber-specific information, route messages, and interconnect local and remote applications for subscribers of multiple wireless networks associated with multiple carriers. Clearinghouse (102) may consist of a cluster of servers generally situated outside the wireless operators' networks and may ensure the interoperation of software applications based internally (hosted on the clearinghouse cluster), externally (anywhere on the internet) with applications running on the target or requesting device over a wireless data connection. Clearinghouse (102) may take the form of a high-capacity, high performance cluster of servers. These servers may provide processing capabilities required to interface to the various wireless carriers, manage database(s) (103, 104), prioritize and queue incoming data requests and outgoing locations, and provide location-specific data or location services.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

The various computing devices disclosed herein typically include a variety of computer readable media. Computer readable media can be any available media that can be accessed by a computing device and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by a computing device. Combinations of any of the above should also be included within the scope of computer readable media.

In FIG. 1, an example of the components and interconnections of Clearinghouse 102 are schematically shown. In this case, multiple wireless (100) and wireline data networks (101) may be served by a single Clearinghouse (102) that connects with the operators (100, 101) via packet data network connections (110). The connections may be either dedicated or virtual. In this example, long term storage databases (103, 104) of user records and data may be stored externally to the Clearinghouse (102) and may be connected by secure packet data links (111). Databases (103, 104) may also be stored internal to the Clearinghouse (102) and the data links (111) may be implemented as LANs or internal buses in the Clearinghouse (102) server cluster.

The Clearinghouse server(s) may be implemented as a redundant cluster of high availability general purpose servers. This Clearinghouse server cluster may host an internal set of location-based services application software or interconnect to dedicated LBS servers via local-area-networks. As depicted in FIG. 1, the internal LBS applications may be hosted on an external set of servers (105) and interconnected to the Clearinghouse via long-haul packet data connections (113). The Clearinghouse (102) may also be connected to a public data network (108) via secure, encrypted channels (114, 115) to externally hosted LBS applications (107) running on non-clearinghouse-controlled but Clearinghouse-supervised external servers. Additional third party providers (106) of services and data such as local maps, point-of-interest databases, traffic information, scheduled events, and weather conditions, for example, may be accessible by the Clearinghouse (102) and internally hosted LBS application (105) via secure packet data links (115, 113) connected and access controlled by the Clearinghouse (102) using the public data network (108) or a private packet network connection (not shown).

In the illustrative embodiment of FIG. 1, the multiple Wireless Carriers (100, 101) may be connected to the Clearinghouse (102) via digital communications links (110). The communications links (110) may carry both location data and subscriber related data between the Clearinghouse (102) and the wireless carrier networks (100, 101) and include a number of physical and logical links. For instance, the location data, in the form of requests or responses, may be carried on a standardized interface such as the 3GPP defined “Lr” interface or the OMA defined “Le” or Mobile Location Protocol (MLP) interface. The GSM-MAP “Lg” (MSC-to-GMLC) interface and the location-related Intelligent Networking CAMEL (Customized Application for Mobile network Enhanced Logic) interface “Lc” (GMLC-to-gsmSCF) may also be present in certain implementations that use or support Operator Specific Services (OSS) using intelligent networking capabilities.

Presence information may be carried on the communications link (110) over interfaces such as the Parlay X presence API or similar interface. Billing information may be transported on a separate logical or physical channel. Provisioning links between the Wireless Carrier networks (100, 101) and the Clearinghouse (102) may also be supported, allowing for uploading of subscriber privacy and preferences profile information. The Clearinghouse (102) ability to add subscribers from external applications (107) may be important for growing the public's access to wireless location services.

The Clearinghouse servers (102) may be connected to multiple databases (103, 104) (internal or external to the server cluster) via high-speed data connections implemented as internal busses, location-area-networks (LANs), or wide-area-networks where geographical redundancy for data is required or geographic deployments are used. The databases (103, 104) may be used to store both static and dynamic data concerning subscriber preferences, subscriber demographics, and time-indexed subscriber historical location information. The databases (103, 104) may also be used to store geographical information such as points-of-interest, maps, dynamic border as well as information regarding time-sensitive events such as road traffic patterns or event (such as football games, political rallies, baseball games, concerts, fireworks displays, etc.).

A suite of LBS applications may allow the Clearinghouse servers (102) to provide to the wireless subscriber a common service experience as well as allowing wireless carriers the ability to offer subscribers a low-cost, low-infrastructure suite of LBS applications. The LBS servers (105) may also contain download facilities allowing subscribers to upload applications to their handsets and mobile devices. Additionally, the internally hosted location-based service applications and/or servers (105) may connect with best-in-class third party providers (106) of wireless applications over data connections (113) allowing the internal suite of applications access to outside data or applications hosted outside the Clearinghouse cluster. These third party providers (106) may also include providers of connectivity external to the Clearinghouse, such as world-wide-web (WWW), Wireless Application Protocol (WAP), Short-Message-Service (SMS), and/or Multimedia Message Service (MMS). These third party providers (106) may also supply mobile device application software or clients based on the Java 2 Micro Edition (J2ME), Binary Runtime Environment for Wireless (BREW), Windows Mobile, and Symbian platforms.

The Clearinghouse servers (102) are connected to external location-based service applications and/or servers (107) via high-speed data connections (113) implemented as location-area-networks (LANs) or wide-area-networks (WANs) over the internet or intranet (108). Externally hosted location based service applications can use the Clearinghouse (102) to obtain subscriber location, obtain subscriber location specific data, or post location-related information to the wireless subscriber via the Clearinghouse (102) under the control of the stored subscriber privacy and preferences settings.

The external location-based service applications and/or servers (107) may also provision new services for a subscriber under strict control of the wireless operator as enforced by the Clearinghouse privacy and preferences policies. An example of this provisioning is when an MNVO uses the Clearinghouse (102) for back-office operations such as adding a locatable mobile device to an existing carrier subscriber account.

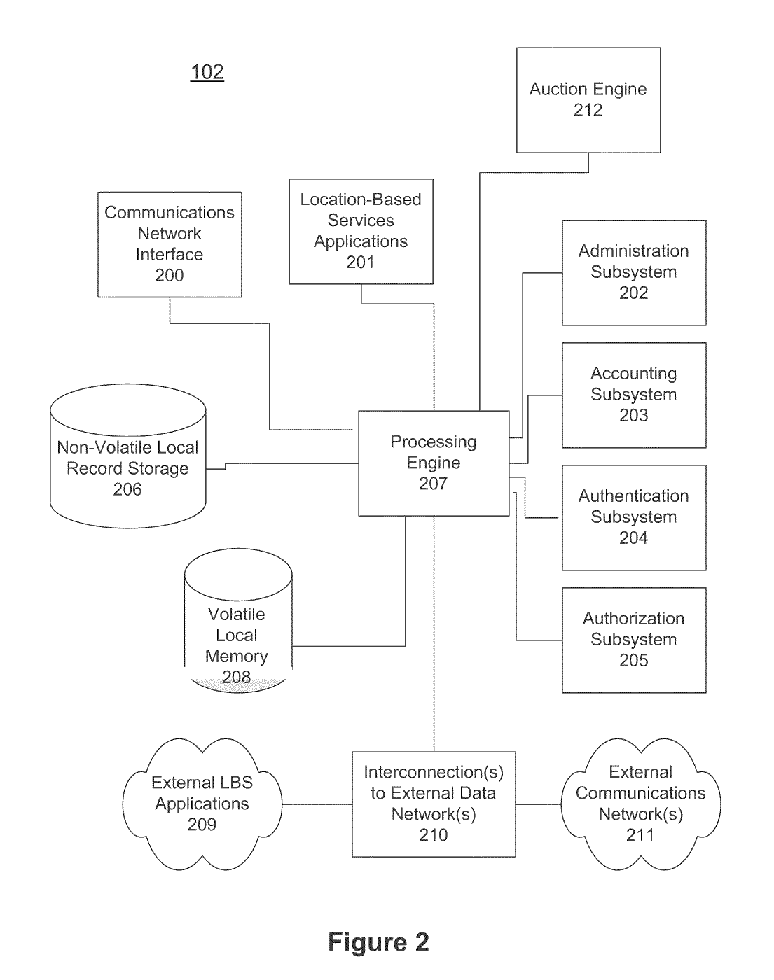

FIG. 2 depicts the internal functional components of an exemplary Clearinghouse implementation (102), including a Communications Network Interface (200), Location-Based Services Application(s) (201), Administration Subsystem (202), Accounting Subsystem (203), Authentication Subsystem (204), Authorization Subsystem (205), Non-Volatile Local Record Storage (206), Processing Engine (207), and Volatile Local Memory (208). As shown, the Clearinghouse implementation (102′) may be coupled via an Interconnections Subsystem (209) to External LBS Application(s) (210) and External Communications Network(s) (211). In this example embodiment, an instantiation of the Communications Network Interface (200) exists for each interconnected communications network. The Communications Network Interface (200) performs communications link management functions such as link load balancing, redundancy control, congestion control and other communications link management functions. The Communications Network Interface (200) provides link level security with heartbeat, periodic re-authentication and challenge-responses. The Communications Network Interface (200) can also provide prioritization based on quality or priority of service for individual requests. The Processing Engine (207) is the core computing power of the Clearinghouse (102) providing internal message flow management, prioritization, and queuing between the Clearinghouse (102) subsystems as well as general purpose computing functions. The Clearinghouse may support a suite of internally hosted Location-based services (201) that either share the Processing Engine (207) capabilities or may be hosted on a network interconnected server platform.

Each of the subsystems/components depicted in FIG. 2 are summarized below:

Administration Subsystem 202: The Administration Subsystem (202) maintains individual user records and services subscription elections. The Administration Subsystem allows for arbitrary groupings of users to form services classes. User subscriber records may include ownership; passwords/ciphers; account permissions; user mobile device capabilities; mobile device make, model, and manufacturer; access credentials; and static or dynamic routing information. In the case where the user mobile device is a registered device under a wireless communication provider's network, the administration Subsystem (202) preferably maintains all relevant parameters allowing for mobile user access of the wireless communication provider's network.

Accounting Subsystem 203: The Accounting Subsystem 203 handles basic accounting functions including maintaining access records, access times, and location applications accessing the Client location allowing for charging for individual mobile devices, applications run on mobile devices, and individual LBS services. The Accounting Subsystem also preferably records and tracks the cost of each access by the wireless communications network provider and the wireless location network provider. Costs may be recorded for each access and location. The Clearinghouse (102) can be set with a rules-based system for the minimization of access charges via network and location system preference selection.

Authentication Subsystem 204: The main function of the Authentication Subsystem 204 is to provide the Clearinghouse (102) with the real-time authentication factors needed by the authentication and ciphering processes used within the internal, radio or external network for user access, user device access, data transmission and LBS-application access. The purpose of the authentication process is to protect the user, radio, and internal Clearinghouse (102) network by denying access by unauthorized users, mobile devices, mobile applications or external location-applications to the radio or Clearinghouse (102) network and to ensure that confidentiality is maintained during transport over a wireless carrier's network and wireline networks.

Authorization Subsystem 205: The Authorization Subsystem (205) uses data from the Administration and Authentication Subsystems (202, 204) to enforce access controls upon mobile user devices, mobile-based applications, and external Location-based applications. The access controls implemented may be those specified in Internet Engineering Task Force (IETF) Request for Comment RFC-3693, “Geopriv Requirements,” the Liberty Alliance's Identity Service Interface Specifications (ID-SIS) for Geo-location, and the Open Mobile Alliance's (OMA) Public Key Infrastructure. The Authorization Subsystem may also obtain location data for a user's mobile device before allowing or preventing access to a particular service or Location-based application. Authorization may also be calendar-based or clock-based dependent on the services described in the user profile record resident in the Administration Subsystem (202). The Authorization Subsystem (205) may also govern connections to external billing system and networks, denying connections to those networks that are not authorized or cannot be authenticated.

Non-Volatile Local Record Storage 206: The Non-Volatile Local Record Storage 206 of the Clearinghouse (102) is primarily used by the Administration, Accounting, and Authentication Subsystems to store user profile records, ciphering keys, network-based location-technology deployments, localized location technology information, and wireless carrier information.

Processing Engine 207: The Processing Engine Subsystem 207 may be a general purpose computer or a cluster of such computers. The Processing Engine 207 manages Clearinghouse resources, provides generic processing power, manages resource schedules, and routes data between subsystems.

Volatile Local Memory 208: The Clearinghouse 102 has a Volatile Local Memory store 208 composed of multi-port memory to allow the Clearinghouse (102) to scale with multiple, redundant processors.

Interconnection(s) to External Data Network(s) 209: The interconnection to External Data networks is designed to handle conversion of the mobile and or Clearinghouse data stream to external LBS applications. The interconnection to External Data networks is also a firewall to prevent unauthorized access as described in the Internet Engineering Task Force (IETF) Request for Comment RFC-3694, “Threat Analysis of the Geopriv Protocol.” Multiple access points resident in the Interconnection to External Data Networks Subsystem 210 allow for redundancy and reconfiguration in the case of a denial-of-service or loss of service event. Examples of interconnection protocols supported by the Clearinghouse (102) include the Open Mobile Alliance (OMA) Mobile-Location-Protocol (MLP) and the Parlay X specification for web services; Part 9: Terminal Location as Open Service Access (OSA); Parlay X web services; Part 9: Terminal location (also standardized as 3GPP TS 29.199-09).

External Billing Network(s) 210: Authorized External Data/Billing Networks and billing mediation systems may access the Clearinghouse's Accounting Subsystem database through this subsystem. Records may also be sent periodically via a pre-arranged interface. Examples of the diverse billing interconnections provided by the external billing network subsystem 210 may include the OMA's Billing Framework 1.0 specification and the Parlay X-Payment Web service.

External Communications Network(s) 211: External Communications Networks refer to those networks, both public and private, used by the Clearinghouse (102) to communicate with location-based applications not resident on the Clearinghouse (102) or on the user device.

Auction Engine 211: The Auction Engine (211) may be implemented as a software application designed to allow re-selling of a mobile user's position to interested bidders. The location of a Clearinghouse registered mobile device may be reused for multiple personalized and anonymous location applications and thus minimizing the cost of location. In an embodiment, the Clearinghouse may auction opt-in subscribers to advertisers. Auctions may include willing subscribers at or around a particular site, subscribers who frequent a site, or the demographic profile of the subscriber.

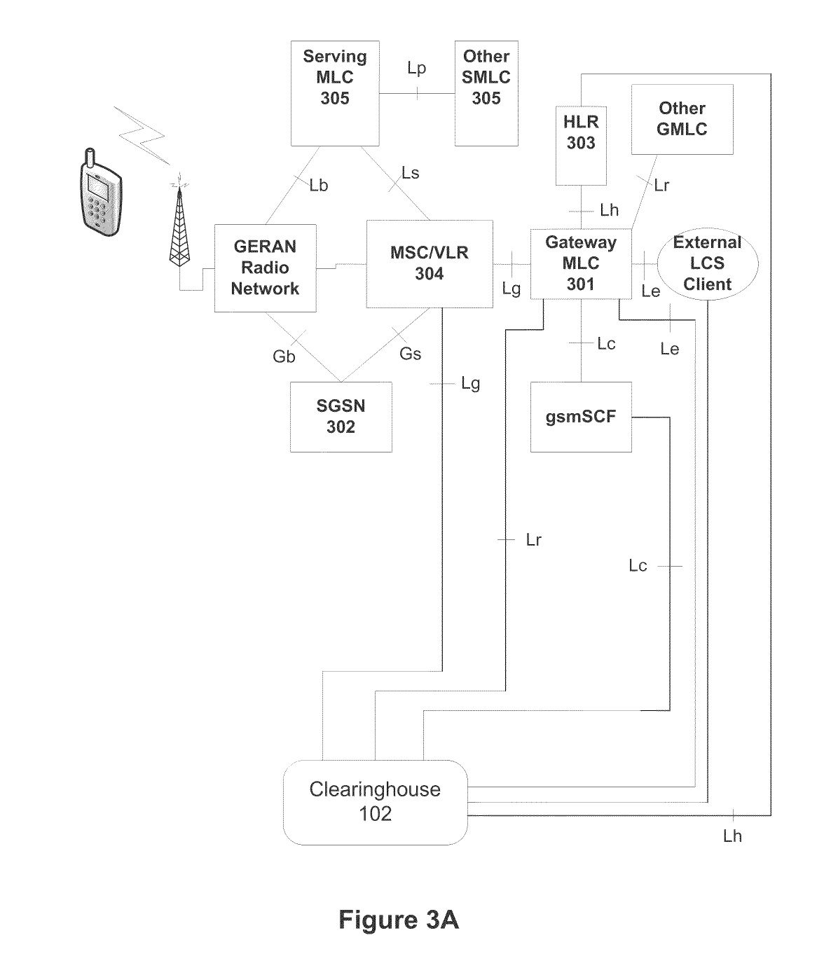

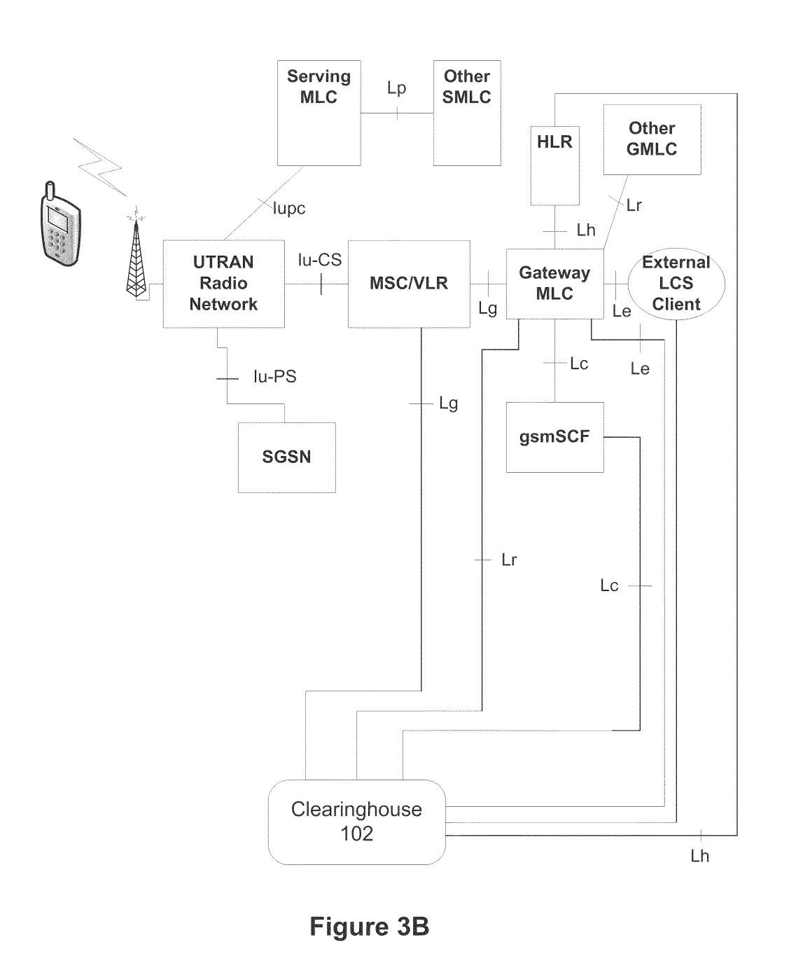

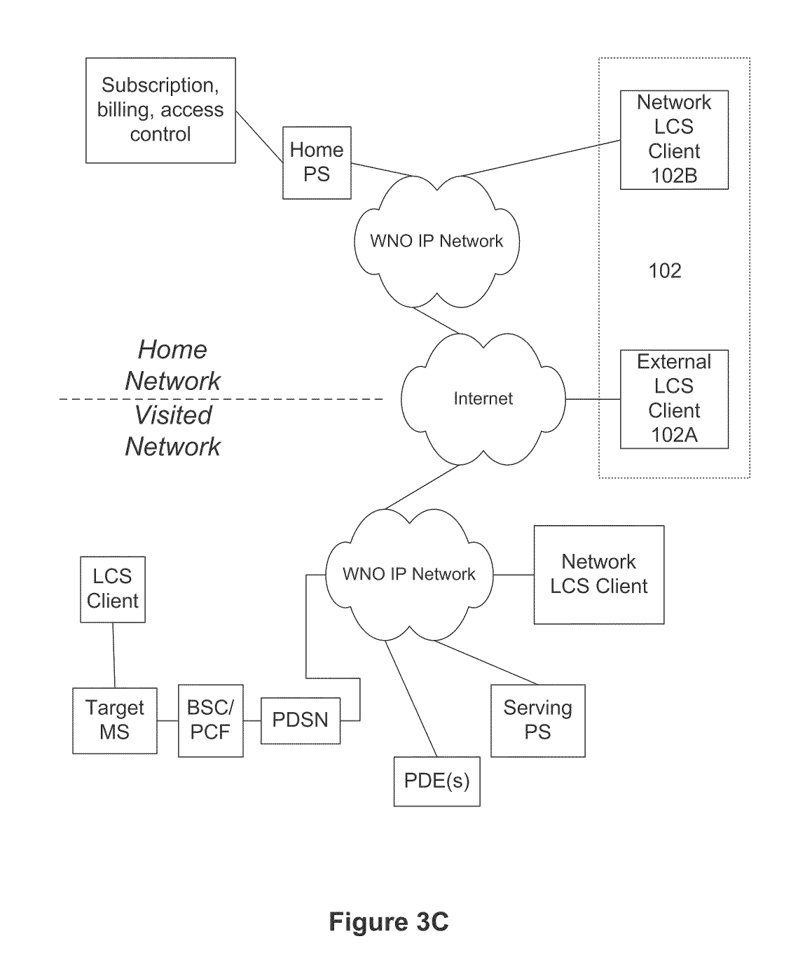

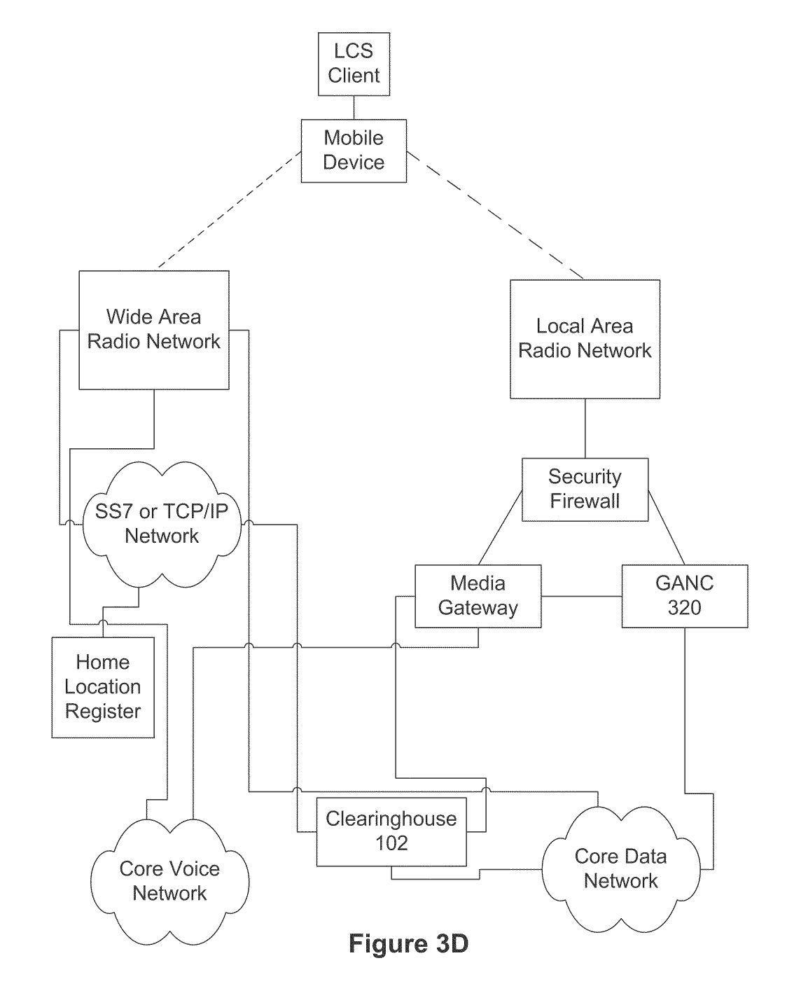

FIG. 3A illustrates how the Clearinghouse (102) may be implemented in a GSM network. Options for integrating the Clearinghouse into the GSM network as a location services client, a Gateway Mobile Location Center (GMLC) (301) or as an Intelligent Networking Client are shown. In addition to the standardized, ‘control plane’ interfaces and nodes shown in FIG. 3A, the Clearinghouse (102) can create a data connection to the wireless device via the Gateway GPRS Support Node (GGSN) or, if allowed, directly to the Serving GPRS Support Node (SGSN) (302). This data connection allows for importation of offered software downloads from the Clearinghouse or Clearinghouse associated 3rd parties and communication between the mobile devices hosted software and the Clearinghouse's associated servers. These associated servers may include location-servers such as those hosting user-plane A-GPS (assisted GPS), EOTD (enhanced observed time difference of arrival) or OTDOA (observed TDOA) location applications or generic applications such as mapping, point-of-interest find-the-nearest, or a friend finder application.

The Clearinghouse (102) acting as an LCS client allows the Clearinghouse (102) to communicate location requests and replies through the wireless carrier's correctly provisioned GMLC. Using the “Le”, LCS client-to-GMLC interface as standardized by the Open Mobile Alliance (OMA) as the Mobile Location Protocol (MLP) interface, the Clearinghouse (102) can request immediate, delay tolerant and periodic sequences of location for subscribers on the wireless network. The LCS client cannot currently (via the OMA MLP version 3.1) provision subscribers on the GMLC nor can the LCS client set subscriber privacy and security settings. When the Clearinghouse is acting as a LCS Client, additional interfaces and APIs will be required for these back-office functions.

If the wireless carrier allows, the Clearinghouse (102) can act as the sole or as an additional GMLC in the carrier's network. Acting as a GMLC in the GSM Network Subsystem (NSS) or core network allows the Clearinghouse (102) to maintain local privacy and security settings for Clearinghouse provisioned subscribers and roamers. The GMLC direct connections to the HLR 303 (Lh) and MSC 304 (Lg) allow for efficient low-accuracy location, presence, availability, and subscriber status (on-call, idle, etc.). If the carrier network has Serving Mobile Location Center(s) (SMLC) 305 deployed, the Clearinghouse GMLC can access high-accuracy location via standardized messaging. If the Clearinghouse (102) is the sole location services GMLC, the Clearinghouse (102) can efficiently schedule GMLC and SMLC location resources, maximizing the SMLC usage by prioritizing and scheduling of location requests. If multiple SMLC-based location technologies are deployed, the Clearinghouse GMLC can also efficiently prioritize and schedule these SMLC resources based on location precision and location latency.

FIG. 3B illustrates how the Clearinghouse (102) may be implemented in a UMTS network. Options for integrating the Clearinghouse (102) into the UMTS network as a location services client, a Gateway Mobile Location Center (GMLC) or as an Intelligent Networking Client are shown. Since the UMTS core network is based on the GSM/GPRS core network, the same capabilities exist for location-based services. The ‘user plane’ services utilizing the Clearinghouse to mobile device data link are also replicable in a UMTS network.

FIG. 3C schematically depicts a representative configuration of the major components of a wireless communications system based on the ANSI and 3GPP2 standards. As shown the packet-based architecture allows the Clearinghouse (102) to be implemented as an external LCS client 102A or as a trusted Network LCS client 102B. The ‘user plane’ services utilizing the Clearinghouse to mobile device data link are also replicable in a CDMA or CDMA2000 network.

FIG. 3D schematically depicts a representative configuration of the major components of a wireless communications system based on 3GPP standards (3GPP Release 6. and TS 44.318) for cross-radio technology called Generic Access networks (GAN). GAN allows communications service delivery to subscriber devices both over wide-area cellular radio networks, but also local area networks. Since the inventive Clearinghouse (102) uses packet-based ‘user plane’ services of the mobile network, the Clearinghouse (102) will function in a GAN or UWA (Unlicensed Wireless Access). The Clearinghouse (102) connects via the GAN controller (GANC) 320 which currently provides cell-ID level location information or connects via the GAN GSN to connect to location technology resident on the mobile device. The ‘user plane’ services utilizing the Clearinghouse to mobile device data link as also replicable in a GAN network. An example of a GAN network would be a hybrid system using WiFi (IEEE 802.11) for localized coverage and a cellular network such as GSM or CDMA for wide-area coverage and service delivery.

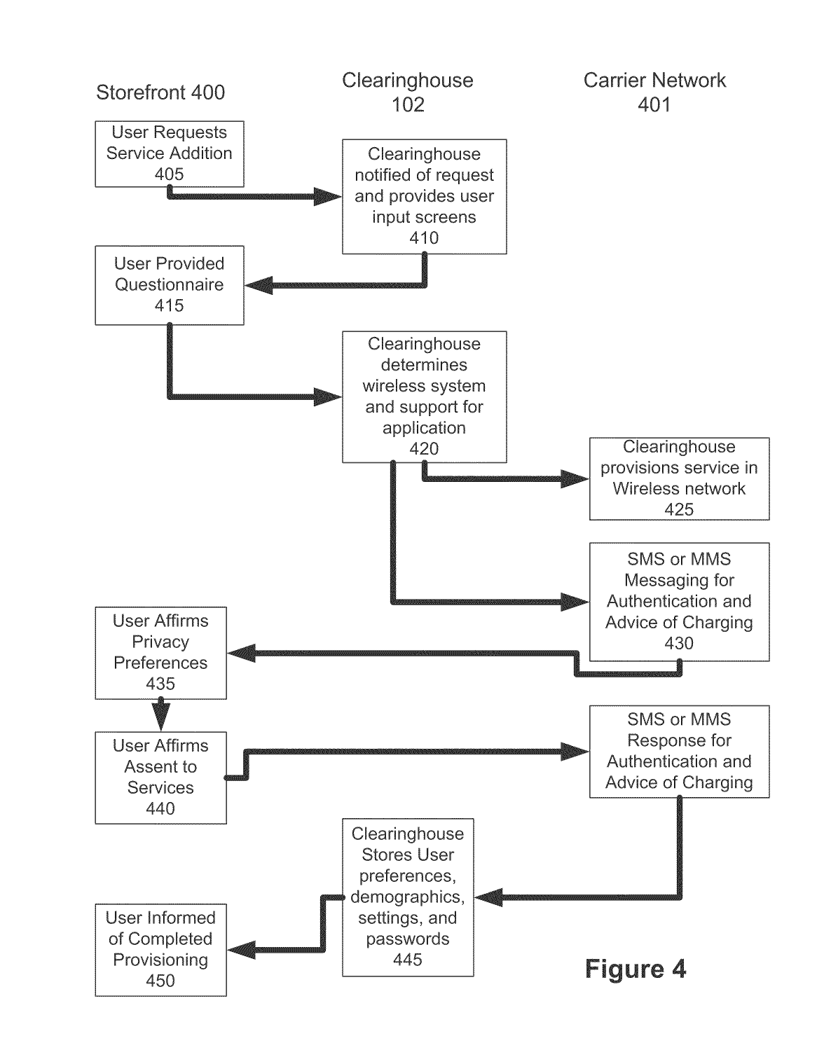

FIG. 4 depicts exemplary operations of the Clearinghouse (102) to provision subscribers within the Clearinghouse and the wireless operator. If the Clearinghouse (102) is allowed by the carrier to operate as a GMLC, then provisioning will occur only within the Clearinghouse using the carrier's SMS or MMS facilities for out-of-band communication and verification with the wireless subscriber.

FIG. 4 depicts an illustrative method for provisioning of a clearinghouse user, also called a subscriber, for clearinghouse services. In one embodiment, Clearinghouse (102) may be used to provision a subscriber from a third party. Provisioning may take place via a storefront 400 provided by a third party retailer or application provider using the clearinghouse to store user details and interface with the wireless carrier or operator. The first step of provisioning services for a new user or a new service for an existing user starts with the user requesting said service 405. This request is provided to the clearinghouse 410 via the third party application, generically called a storefront. This storefront application can be entered by the user or as a back-office function by the third party retailer.

An important aspect of the provisioning method is the entering of user identification data allowing the Clearinghouse (102) to ascertain if the user is already provisioned on the Clearinghouse (102). The identification data is processed by the Clearinghouse (120) and a questionnaire is composed by the clearinghouse to collect the necessary data for service provisioning and provided to the user 415. The identification data may include demographic information, security and privacy preferences as well as permissions for accessing of the user's wireless carrier. From the questionnaire, the Clearinghouse (102) may determine the user's wireless network and support for the requested application or service to be provisioned 420. The Clearinghouse (102) may interact with the wireless network to provision the service 425 and uses the wireless network's messaging facilities to complete the transaction outside the storefront. By using the wireless network and the mobile device's messaging capabilities, both a greater level of security and service can be obtained since the user is preferably required to have the device in-hand for provisioning. Using the wireless messaging capability, the user is delivered a summary of the selected security, privacy, and billing preferences 430. Using the wireless messaging facility, the user affirms the selection of privacy preferences 435 and assent to services 440, upon which the clearinghouse completes processing and storage 445 before informing the user of success of provisioning 450.

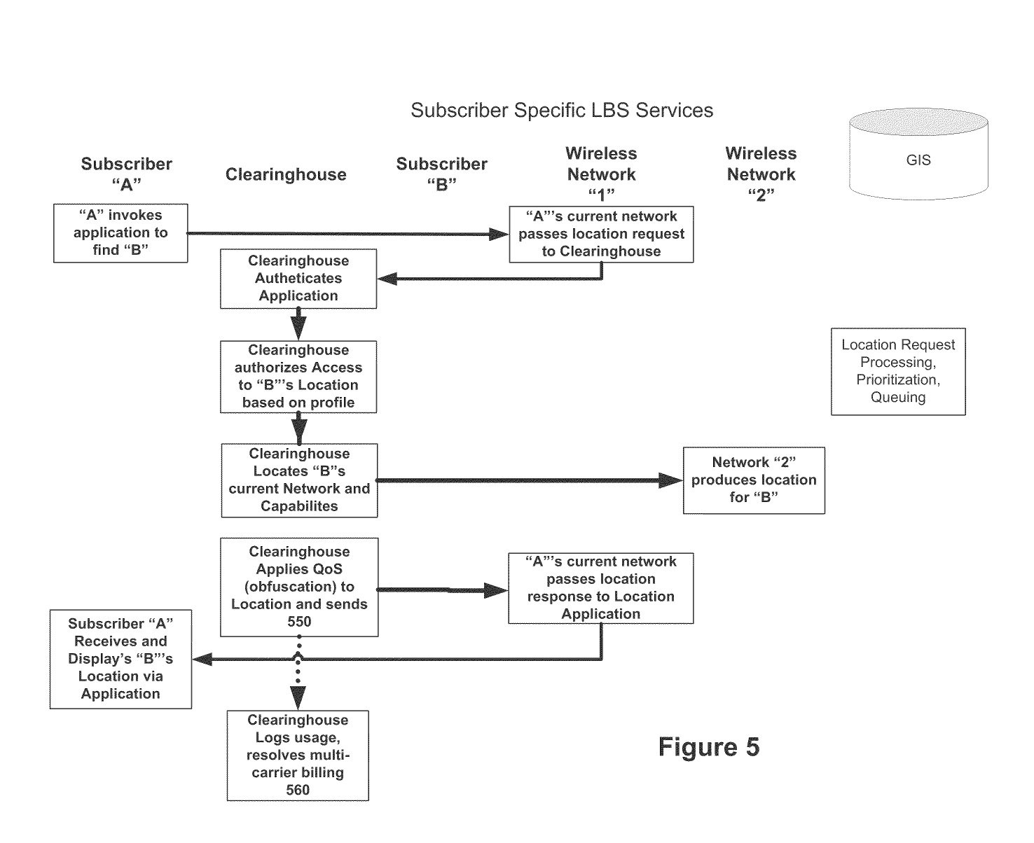

FIG. 5 shows the operations of the Clearinghouse (102) to facilitate and deliver cross-carrier service while maintaining subscriber security and privacy. Using the clearinghouse, subscriber-specific services may be granted on the basis of pseudonyms or temporary identifiers as well as permanent identifiers linked to permanent wireless network identifiers such as mobile ID, phone number, email address and the like. In this case, the Clearinghouse (102) acts to translate between the permanent and pseudonymous, and in some cases temporary, identifiers. FIG. 5 provides an illustrative method for providing subscriber specific location based services. In this example, a clearinghouse user locates another clearinghouse user under the clearinghouse security and privacy regime on a different wireless network. When a subscriber, called “A” in this example, attempts to locate another subscriber, called “B” in this example, using a mobile device based software application 501, the Clearinghouse (102) is used to provide security, privacy, routing and any inter-carrier messaging. In this example the Clearinghouse (102) also obfuscates (550) the location produced by Wireless Network 2's geolocation capabilities according to Subscriber B's security and privacy profile for location accuracy before sending the location to the requesting user, Subscriber A. The Clearinghouse (102), as shown in FIG. 5, also can be used to perform billing operations as established with the wireless network operators, especially in the case of cross-carrier billing resolution (560).

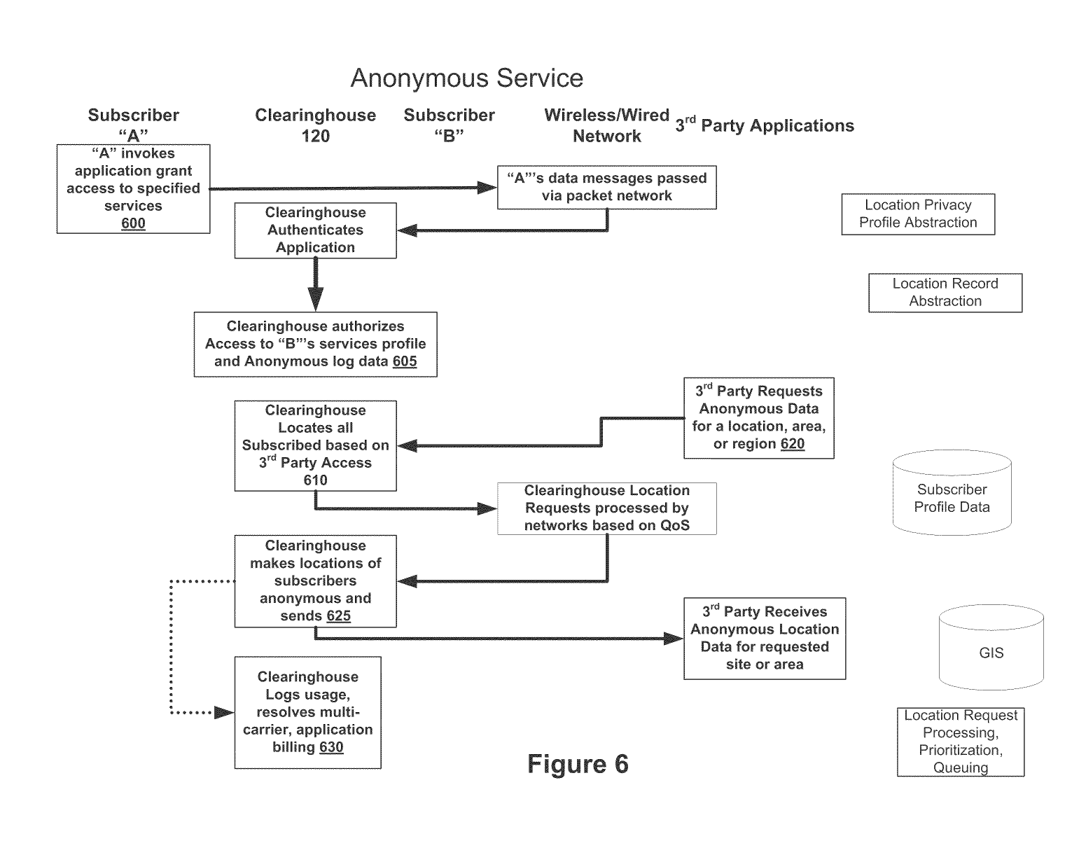

FIG. 6 shows the operations of the Clearinghouse (102) to facilitate and deliver carrier independent service while maintaining subscriber security, privacy and anonymity. The Clearinghouse (102) can be used to provide anonymous location data to third parties as allowed by subscribers. Such data can be resold in relation to a location, area or region, or based on the demographic profile of the subscriber if allowed. In the illustrative example depicted in FIG. 6, the election to allow anonymous location data to be provided is done at service provisioning 600 or at another stage prior to anonymous location data collection. In the example, the grant for anonymous location data (605) is performed at the Clearinghouse (102) using a data connection to the subscriber's mobile device, although back-office or off-line methods may also be used.

In the illustrative example shown in FIG. 6, the third party requests anonymous location data associated with a location, area or region of interest 620. This request will also include a specific time and duration for the anonymous location data either in the past or the future. Alternatively, an accumulation point may be used to terminate the collection once a specified number of locations have been reached. In this example, the data collection is immediate for a set duration. During the collection time, the clearinghouse collects all locations from subscribers granting anonymous location data 610. This collection may be passive or active.

With passive polling, the clearinghouse relies on location-of-opportunity where location requests by users directed to other applications are re-used by collecting them and then making them anonymous. With active polling, likely users are queried by the Clearinghouse (102) using the wireless network's location polling methods (for example the AnyTimelnterrogation (ATI) method described in technical standards specifications of 3GPP). Likely users are those users who grant anonymous access and are likely based on historical behavior to be in or near the area-of-interest. Once the data is collected, the location data is pre-processed to fulfill both the minimum accuracy required by the requesting application and the accuracy allowed by the various users involved. Next the location data is anonymized and delivered 625. As a final step, any billing related matters are completed amongst the third party application, clearinghouse, and involved wireless networks 630.

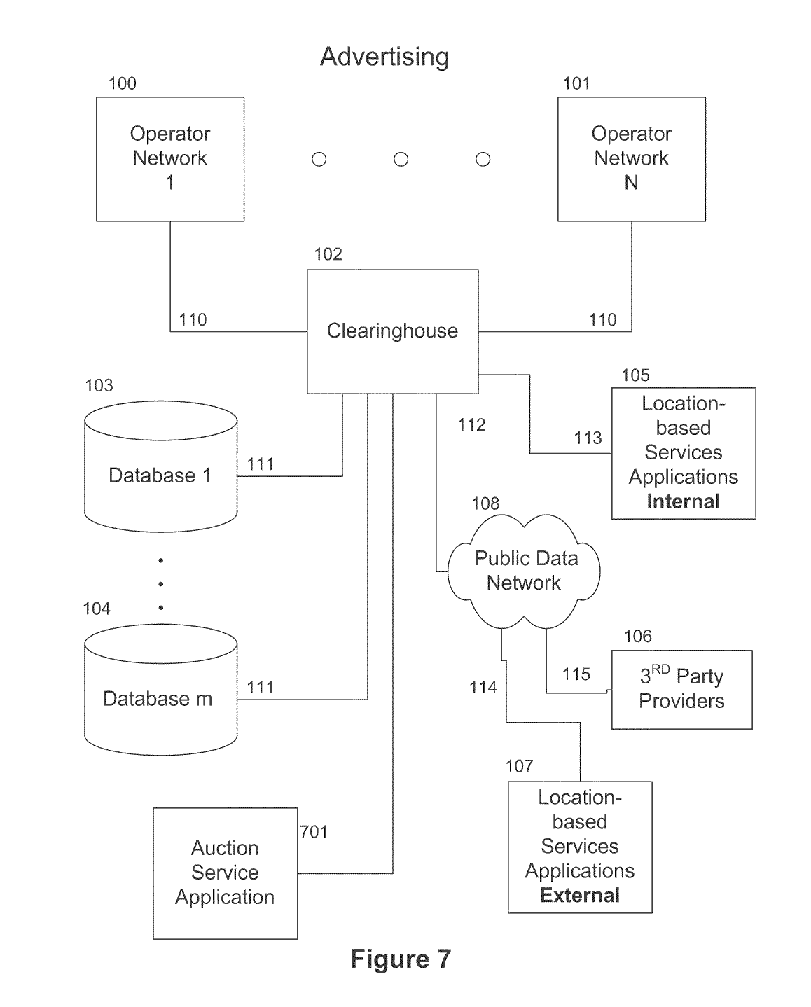

FIG. 7 depicts the interconnections of the Clearinghouse (102) with the added auction services application (701), shown here as external to the Clearinghouse (102) but capable of being hosted internal to the Clearinghouse server cluster. In this case, the auction is being used for anonymous granting of advertising rights to the Clearinghouse registered mobile devices.

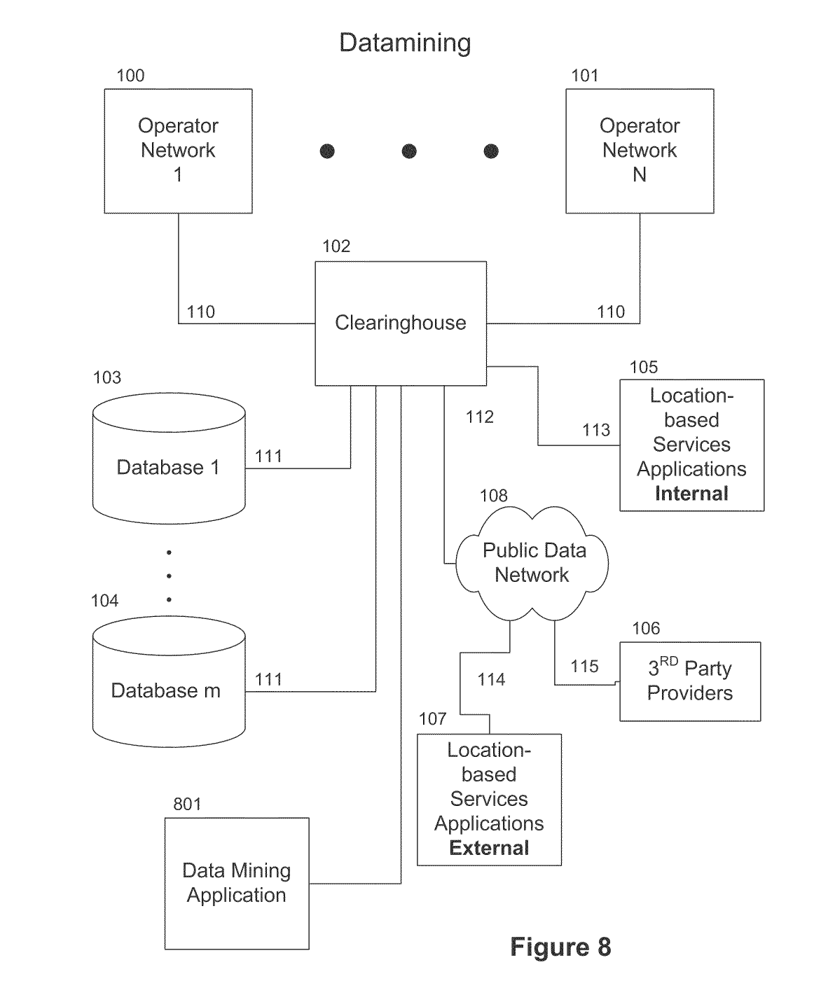

FIG. 8 depicts the interconnections of the Clearinghouse with the added datamining application (801), shown here as external to the Clearinghouse (102) but capable of being hosted internal to the Clearinghouse server cluster. In this case, the datamining is being used for anonymous mining of the Clearinghouse registered mobile device's historical locations and activities.

### An Illustrative Example

The following description explains how the Clearinghouse (102) may be employed to support an LBS application for social networking.

As an illustrative example of the Clearinghouse support for an external LBS application, a social networking LBS application called “friend finder” may be deployed using the Clearinghouse for provisioning with multiple carriers. The subscriber may discover the LBS application via a social networking web application. An online questionnaire may be one method for establishing that the subscriber's carrier uses the Clearinghouse and that the “friend finder” application is available. Other methods such as interactive voice response systems or human operators are also possible.

Since in some cases the subscriber may be unaware of the actual wireless operator network he or she is using, the Clearinghouse (102) may poll the connected wireless carriers to discover the subscriber's affiliation. Since the subscriber may be unaware of the location capabilities or even the make and model of their mobile device, this information may also be discovered by polling the connected wireless carriers.

The Clearinghouse (102) may optionally use SMS or MMS messaging to establish communication with the subscriber's mobile device. The subscriber would confirm receipt back to the Clearinghouse, confirming the subscriber device and entered settings. Notification of required software or configuration downloads to enable the desired application would also be supplied via SMS or MMS messaging.

In this illustrative example, billing and charging may be established via the provisioning application such as a WWW site with credit card entry. The Clearinghouse may also, with the appropriate contractual agreements in place, add the newly provisioned service to the subscriber's wireless bill via a billing system interconnection provided by the Clearinghouse.

As part of the provisioning process through the external LBS application example, the user agreement and privacy settings may be transmitted by the Clearinghouse (102) through the external LBS application for acceptance by the wireless subscriber. Confirmation of the acceptance and advice-of-changing may be managed via SMS or MMS requiring that the location application user be in physical possession of the phone during the provisioning process. A temporary personal identifier may be generated during the provisioning session. This identifier may be delivered to the subscriber via the acceptance SMS and entered into the provisioning application to finalize the provisioning process. Once provisioning is complete, the user may be asked to create a permanent, personalized password and the user safety, security and privacy settings reviewed.

Errors encountered during the registration and provisioning process in this example may handled by the external LBS application, with the Clearinghouse (102) acting as a secure storage node for user information, wireless subscriber information, and passwords or security settings.

Using the “friend finder” LBS application as an illustrative example, the Clearinghouse (102) may provide core functionality to enable the application regardless of the application being internally or externally hosted. The Clearinghouse (102) may store a ‘buddy’ list for each provisioned subscriber, time-of-day location access information, and each “buddy's” location access and accuracy rights for each ‘buddy’ or ‘buddy group.’ The Clearinghouse (102) may also hold time-indexed historical location allowing for reduction in locations requested from the wireless carrier by caching and redistributing the most recent location from the ‘friend finder’ LBS application or any other LBS application. When a location update is required or requested, the Clearinghouse (102) may determine the appropriate carrier based on cached data or polling for presence and availability from the designated carrier for that user or the most likely subset of carriers given the cached or roaming information.

Once the external LBS application has been fully registered and provisioned, and any client software or configurations on the mobile device have been installed, the user can control the application and application settings via the mobile device communications with the Clearinghouse without duplication at the external LBS application server or in the carrier network. Settings include resetting to default behavior and settings or user customization of settings. Settings include maintenance of the ‘buddy’ list members, location accuracy allowed for each member or group, location based messaging including advertising, times when location is allowed, times when location-based messaging is allowed, default handling of invitations from other users, message delivery format (voice, text, etc) and language settings.

With the Clearinghouse handling all data storage, transaction management, obtaining of location, and interfacing to the desired messaging means, a wireless carrier or external services enterprise can easily create a location-based service application or suite of applications with minimum outlay of infrastructure. The subscriber also benefits from the end-to-end automated solution for registration, provisioning, and privacy security across multiple carrier and LBS applications allowed by the Clearinghouse concept.

### ADDITIONAL EMBODIMENTS

Location Cache/Reuse for multiple services: Locations of subscribers can be reused for multiple personalized and anonymous location applications, thus minimizing costs associated with location services. A system and method for cost-reduction of location based services by using a location Clearinghouse (3rd party) to transact a location on a subscriber and then reuse the location to: 1) service any outstanding requests for that subscriber, 2) aggregate for anonymous location applications, and 3) service any 4th party push applications allowed under the subscriber preferences.

Push Ad Delivery to Anonymous Subscriber: Again, locations of subscribers can be reused for multiple personalized and anonymous location applications, and this can minimize costs. In this concept the subscriber is anonymous to the advertiser, known only by demographics, current location, time-of-day, etc. Under control of the subscriber profile, targeted Advertisements may be delivered to the subscriber. These advertisements may include links to opt-in, opt-out page or the advertiser's web site.

Normalization Processing: In this embodiment, the location Clearinghouse serves to abstract and standardize subscriber profiles, subscriber privacy settings, and the format of shared cross-carrier, and cross-technology data (such as location).

Location Enabled Secondary Ticket Exchange

In various embodiments, a secondary exchange services application may be provided to enable a location-enabled peer-to-peer electronic marketplace for the sale and resale of goods and services. Such a secondary exchange services application may also be referred to in some embodiments as a buyer-seller exchange application. While the present disclosure provides many examples in the context of the sale and resale of event tickets, the techniques described herein are not limited to event tickets and, rather, can be applied in any type of environment associated with a peer-to-peer electronic marketplace, including environments associated with electronic marketplace activities other than event tickets such as food and drink sales, retail environments, entertainment environments, and the like. Depending on the environment, increasing the flow of timely and relevant location based information in accordance with some embodiments may increase the efficiency of the peer-to-peer electronic marketplace, reduce costs, result in higher sales, drive sales to new customers, and provide many other personal and/or commercial benefits.

Qwikets™ is one embodiment of a buyer-seller exchange application that may be particularly suited for use in a location-enabled peer-to-peer electronic marketplace for the sale and resale of event tickets. In an embodiment, the buyer-seller exchange application may be a client application that is executable on a mobile device such as the Apple™ iPhone™. Event tickets may be traditional physical tickets such as those printed on paper, electronic tickets such as those available in a computer readable file format, or other forms of tickets that may be used for various events and venues. Since tickets to shows, concerts, sporting or other events are both time and location sensitive, use of a peer-to-peer electronic marketplace may allow buyers and sellers to make transactions with the assurance that tickets are available and that a purchase is imminent.

The buyer-seller exchange application may support both primary and secondary market players, thus allowing an electronic channel for primary vendors and distribution via secondary market vendors. Ticket vendors and buyers may have profiles and rating and ranking factors linked to persistent pseudonyms, thus allowing both buyers and sellers to remain anonymous until the actual transaction (or longer in cases where a third party intermediary is used).

Secondary market resale is a form of arbitrage auction in which tickets sold through secondary sources sell for less or more than their face value depending on demand, which itself tends to vary as the event date approaches. The buyer-seller exchange application, by allowing users to access a listing service of available or needed events, venues, and tickets, enables a new mobile electronic arbitrage with the assurance that the ticket buyer and seller are in close proximity so that the sale may be completed with minimal latency. Listings may be sorted by distance to the buyer using near real-time location techniques, and users may send messages to each other anonymously through the arbitrage system to avoid revealing their identity until they decide to complete a transaction. The buyer-seller exchange application may also provide secondary databased information such as detailed area maps to further assist buyers in finding sellers. The Clearinghouse (102), when used in conjunction with the buyer-seller exchange application, thus has the advantage of being able to coordinate the locations of buyer and seller regardless of the location technique or technology or the location plane used to develop the location.

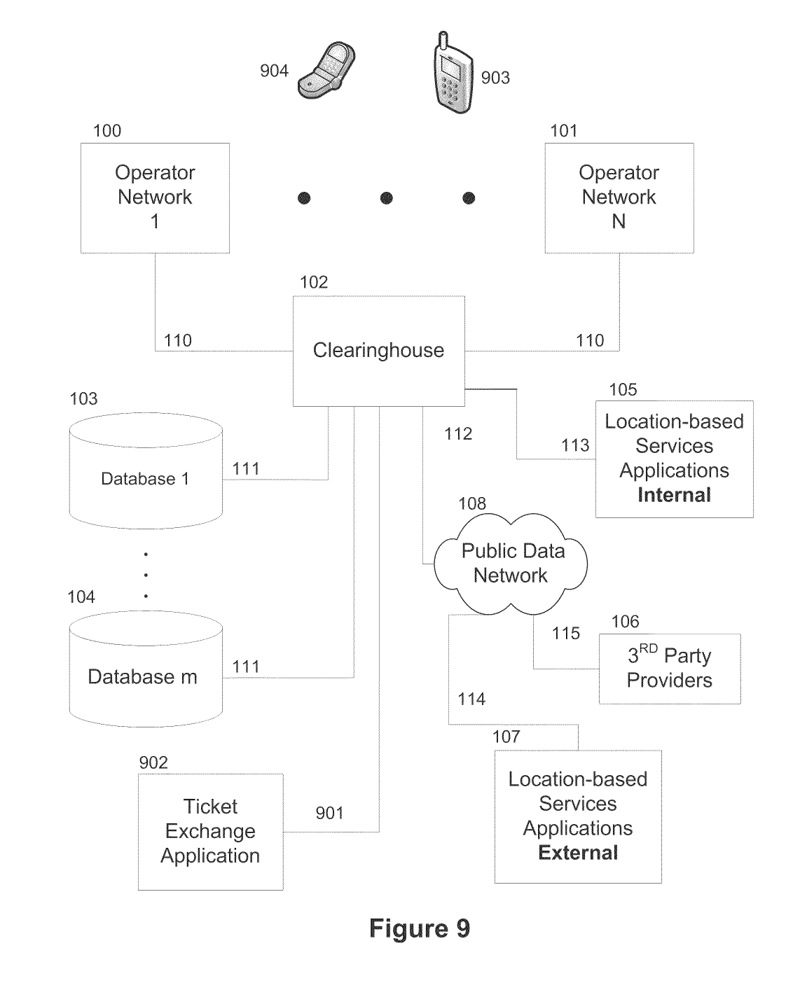

FIG. 9 depicts the interconnections of the Clearinghouse (102) with the added ticket exchange application 902, shown here as external to the Clearinghouse 102 and interconnected via a packet data connection 901 but capable of being hosted internal to the Clearinghouse server cluster. In one embodiment, the ticket exchange application 902 is the buyer-seller exchange application. The buyer-seller exchange client application may be made available for download via an application server or other means for downloading to a suitable mobile device 903 or 904. The buyer-seller exchange core application 901 may be a software package hosted on the Clearinghouse cluster or as an external application serviced by the Clearinghouse.

Buyer-seller exchange application users may create a profile for use when making a posting for buying or selling tickets with peers. Buyer-seller exchange application users may, in some embodiments, be required to provide a username, password, and email address. Optionally, users may also provide their age, a tagline/slogan, website URL, gender, and phone number. In cases where billing is handled by the buyer-seller exchange application, credit card or bank account information may be part of user and seller profiles.

The user and seller profiles may also comprise generated information. For example, community ratings and service reliability scores may be generated for buyers and sellers on the basis of polling or other feedback and stored in a database.

When creating an offer to buy or sell tickets, users may designate an event and provide information such as venue, location, and date/time. Users may provide the number of seats, seat description, and asking price. A database of location addresses may be used to abstract the event location to latitude and longitude for storage in the listing information for later use by the buyer-seller exchange core application. In an embodiment, the buyer-seller exchange application may allow users to access ticket listings based on the proximity of the buyer and/or seller.

As shown in FIG. 7 of U.S. patent application Ser. No. 11/857,173 “Providing Subscriber-Specific Information Across Wireless Networks,” the secondary exchange service 901 operates as an online auction server while the buyer 903 and seller 904 operate as clients of the server. The buyer 903 and seller 904 are shown in FIG. 9 as mobile phone based applications, but combinations of wired and wireless devices are supported.

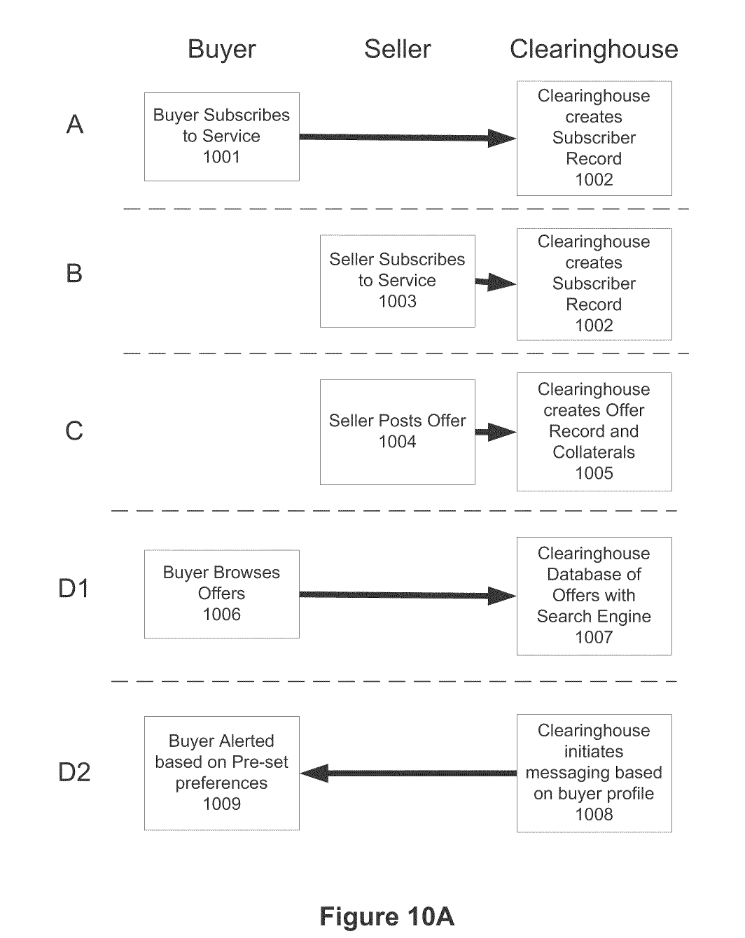

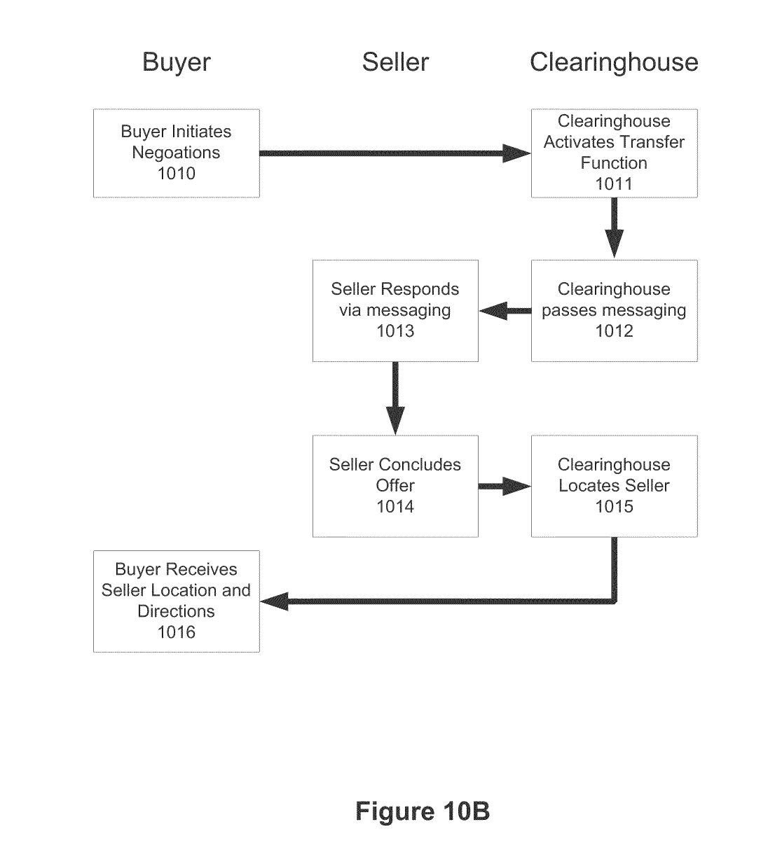

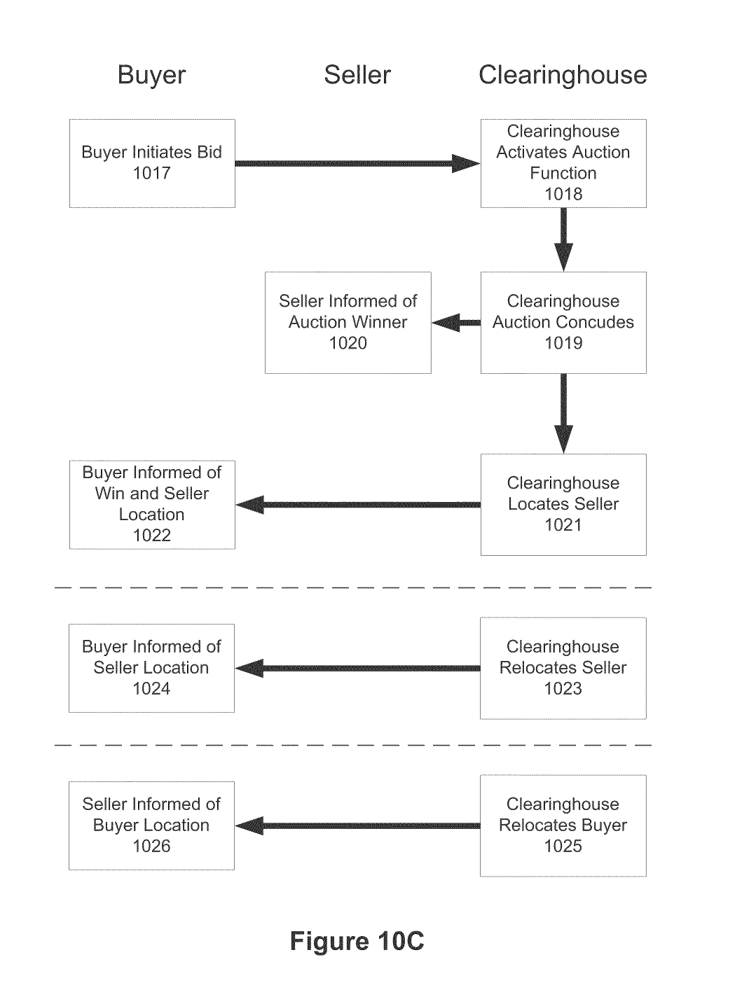

FIGS. 10a, 10b and 10c depict some exemplary events and transactions describing embodiments of a buyer-seller exchange application and service.

FIG. 10a illustrates discrete events provided by the service prior to the purchase. In Step A, the buyer subscribes to the buyer-seller exchange service 1001. By setting up a data connection with the clearinghouse or third party entity and entering profile information, the clearinghouse may, in response, create a new subscriber record 1002. In Step A, there is the potential to charge the subscriber (the buyer) for the subscription to the service, to setup an agreement to advertisement in conjunction with the service, or to charge a third party for a sponsorship of the subscription account.

In FIG. 10a, Step B, the seller subscribes to the buyer-seller exchange service 1003. By setting up a data connection with the clearinghouse or third party entity and entering profile information, the clearinghouse may, in response, create a seller subscriber record 1002. In Step B, there is the potential to charge the subscriber (the seller) for the subscription to the service, to setup an agreement to advertisement in conjunction with the service, to setup a revenue sharing agreement, set up an agreement for a fixed price per ticket, or to charge a third party for a sponsorship of the subscription account.

In FIG. 10a, Step C, the seller may post and offer for sale 1004 via a data connection to the clearinghouse-based buyer-seller exchange application. The offer for sale may be a fixed price offer or an auction item with a set end time and/or a reserve price. In the case of an auction service, the reserve price may be set to be manually or automatically incremented or decremented as the auction nears completion or as the event time approaches.

For any offer for sale, the clearinghouse may create collateral information associated with the offer for sale. Collateral information may include event-related information such as seating maps, parking, relevant news articles, and/or traffic information. Collateral information may be presented to the buyer or seller via data connections formatted as text and or graphical images in accordance with the device capabilities, profile information and bandwidth of the data connection.

In FIG. 10a, Steps D1 and D2 are used to show the equivalent steps dependent on the type of sale offer. In Step D1, the Buyer uses a data connection to browse the sales and collateral information stored on the clearinghouse. In step D2, the Buyer is alerted by the clearinghouse of an event that meets preselected criteria in the subscriber profile (e.g., tickets are available for specific performers at a specific venue, tickets are available for specific performers in a specific price range, tickets are available from a specific seller, or a performance of a specific genre within a specific travel range within a specific date range has tickets available). Additionally and optionally, when viewing ticket listings the user may sort the listings based on their distance relative to the user who posted the ticket. In one embodiment, the distance may be based on the current location of both the buyer and seller.

FIG. 10b illustrates an exemplary peer-to-peer transaction as facilitated by the clearinghouse. First, the buyer may inform the clearinghouse of an intent to purchase and initiate negotiations with the seller 1010 via the clearinghouse. In response, the clearinghouse may activate a transfer function 1011 allowing the buyer and seller to converse either via a data connection or a voice connection. The clearinghouse may pass the offer to purchase along with authorized buyer information (for instance, the name, number or pseudonym of the buyer). The seller may respond to the offer for purchase 1013 via the forwarded data connection to the buyer. Once the buyer and seller are in agreement, the seller may conclude the offer for sale 1014, allowing the clearinghouse to re-aggregate remaining and available tickets for the event. The clearinghouse may then locate the seller 1015 using queries to the wireless carrier's Global Mobile Location Center (GMLC) or Mobile Positioning Center (MPC) for a control-plane location. Alternatively, the clearinghouse may query the seller's mobile phone directly for a user-plane location via the clearinghouse to seller data connection. In some cases the clearinghouse may request both a control plane and user plane location to prevent location spoofing or to mitigate a response failure in either location request. Once the seller is located 1015, the clearinghouse may pass the seller location 1016 to the buyer allowing for physical exchange of the tickets as well as exchange of payment. The clearinghouse may use the location information to create directions for the buyer. The seller's location may be presented as a map image or, if requested, the clearinghouse may also locate the buyer. In some embodiments, text directions or a mapped route may be generated by the clearinghouse and presented to the buyer.

In FIG. 10c, an exemplary scenario describing ticket sales made via auction is illustrated. As detailed in FIG. 10a, Step C, the seller has posted an offer 1004. The clearinghouse collateral information has been made available to the buyer in steps FIG. 10a Step D1 or FIG. 10a Step D2. Referring to FIG. 10c, the buyer initiates a bid 1017 allowing the clearinghouse to enter the bid in the auction application 1018. The buyer may query the clearinghouse for auction information or the clearinghouse may push periodic updates to the buyer during the auction process. When the auction concludes 1019, the seller is informed of the winning bid and bidder 1020. The clearinghouse then locates the seller 1021 by making a query to the wireless carrier's Global Mobile Location Center (GMLC) or Mobile Positioning Center (MPC) for a control-plane location. Alternatively, the clearinghouse may query the seller's mobile phone directly for a user-plane location via the clearinghouse-to-seller data connection. In some cases the clearinghouse may request both a control plane and user plane location to prevent location spoofing or to mitigate a response failure to one of the location requests. Once the seller is located 1021, the clearinghouse passes the auction results and the seller location 1022 to the winning buyer allowing for the physical exchange of the tickets and exchange of payment. The clearinghouse may use the location information to create directions for the buyer. In one embodiment, the seller's location may be presented as a map image or, if requested, the clearinghouse will also locate the buyer allowing text directions or a mapped route to be generated by the clearinghouse and presented to the buyer.

For a predetermined interval after the conclusion of the transaction and/or until permission of either party is revoked, the buyer and seller may continue to locate or relocate each other. In each case, the clearinghouse may provide the location information in response to a query. In the case of the buyer making the request, the clearinghouse may relocate the seller 1023 and pass the seller's location, compass heading, map of the seller's location, address, or text directions to the buyer 1024. In the case of the seller requesting the location, the clearinghouse may locate or relocate the seller 1025 and pass the seller's location, compass heading, map of the seller's location, address, or text directions to the buyer 1026.

The clearinghouse may also offer a proximity location function where the buyer and seller are alerted via distinctive tones or screen flashes when the clearinghouse detects the buyer and seller are within range of each other.

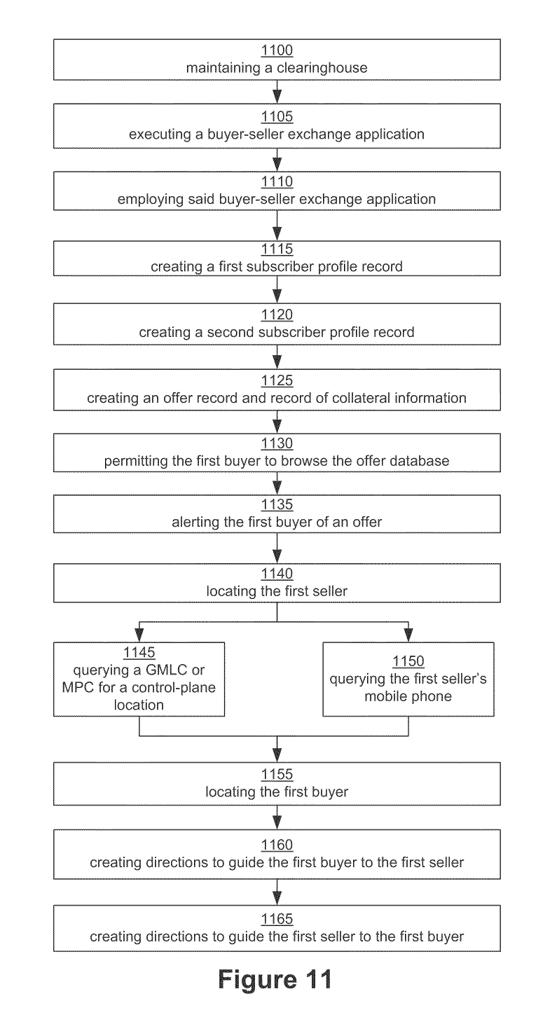

Referring now to FIG. 11, illustrated is an exemplary process for providing a marketplace for buyers and sellers of time sensitive items. One or more of the illustrated operations may be omitted, and the illustrated operations do not imply a particular order. In one exemplary method, process 1100 illustrates maintaining a clearinghouse that is accessible via a telecommunications network to a plurality of buyers and sellers. In process 1105, a buyer-seller exchange application is executed on a computer operatively coupled to the clearinghouse. The method further comprises employing the buyer-seller exchange application to sort listings of items for sale as a function of distance to the buyer 1110.

In one embodiment, a first subscriber profile record may be created 1115 in response to a first buyer subscribing to the clearinghouse and providing profile information for the first buyer. Additionally and optionally, a second subscriber profile record may be created 1120 in response to a first seller subscribing to the clearinghouse and providing profile information for the first seller.

In response to the first seller posting an offer for sale via the buyer-seller exchange application, an offer record and record of collateral information associated with the offer record may be created 1125 in an offer database. In an embodiment, the first buyer may be permitted to browse the offer database 1130.

In one embodiment of the method, the first buyer may be alerted 1135 of an offer that meets preselected criteria in the first subscriber profile record. Additionally and optionally, the first seller may be located and the first seller's location may be communicated 1140 to the first buyer. The first seller may be located by querying a wireless carrier's Global Mobile Location Center (GMLC) or Mobile Positioning Center (MPC) for a control-plane location 1145. Alternatively, the first seller may be located by querying the first seller's mobile phone 1150.

Additionally and optionally, the first buyer may also be located and the first buyer's location may be communicated 1155 to the first seller. As discussed above, directions may be created to guide the first buyer to the first seller 1160. Similarly, directions may be created to guide the first seller to the first buyer 1165.

### CONCLUSION

The true scope the present invention is not limited to the presently preferred embodiments disclosed herein. For example, the foregoing disclosure of presently preferred embodiments uses explanatory terms, including capitalized terms such as Clearinghouse, Communications Network Interface, Location-Based Services Application, Administration Subsystem, Accounting Subsystem, Authentication Subsystem, Authorization Subsystem, Non-Volatile Local Record Storage, Processing Engine, Volatile Local Memory, Interconnections Subsystem, External LBS Application, External Communications Network, and the like, which should by no means be construed so as to limit the scope of protection of the following claims, or to otherwise imply that the inventive aspects of the illustrative embodiments are limited to the particular methods and apparatus disclosed. Moreover, as will be understood by those skilled in the art, many of the inventive aspects disclosed herein may be applied using future wireless protocols, networks, and location techniques. In many cases, the place of implementation (i.e., the functional element) described herein is merely a designer's preference and not a hard requirement. Accordingly, except as they may be expressly so limited, the scope of protection of the following claims is not intended to be limited to the specific embodiments described above.

What is claimed:

1. A system for providing a peer-to-peer, location-based marketplace for buyers and sellers of time sensitive items, comprising:
a clearinghouse; and
a buyer-seller exchange application configured to execute on a computer operatively coupled to said clearinghouse;
wherein said buyer-seller exchange application is configured to sort listings of items for sale as a function of distance to the buyer.

2. A system as recited in claim 1, wherein said buyer-seller exchange application is configured to facilitate the sale of event tickets.

3. A system as recited in claim 2, wherein said event tickets include paper-based tickets.

4. A system as recited in claim 2, wherein said event tickets include electronic tickets.

5. A system as recited in claim 1, wherein said buyer-seller exchange application is configured to maintain profiles for buyers and sellers, and to maintain rating and ranking information linked to persistent pseudonyms for said buyers and sellers.

6. A system as recited in claim 5, wherein said persistent pseudonyms are employed to maintain anonymity of a specific buyer and seller at least until an actual transaction is consummated between said specific buyer and seller.

7. A system as recited in claim 1, wherein said buyer-seller exchange application is configured to facilitate anonymous messaging between buyers and sellers.

8. A system as recited in claim 1, wherein said buyer-seller exchange application is configured to provide area maps to assist buyers in finding sellers.

9. A system as recited in claim 1, wherein said buyer-seller exchange application is configured to execute on a web server operatively coupled to said clearinghouse, and to communicate with the buyers and sellers through said clearinghouse.

10. A system for providing a peer-to-peer, location-based marketplace for buyers and sellers of tickets, comprising:
a clearinghouse; and
a buyer-seller exchange application configured to execute on a computer operatively coupled to said clearinghouse;
wherein said buyer-seller exchange application is configured to sort listings of tickets for sale as a function of distance to the buyer; and
wherein said buyer-seller exchange application is configured to maintain profiles for buyers and sellers, and to maintain rating and ranking information linked to persistent pseudonyms for said buyers and sellers.

11. A system as recited in claim 10, wherein said persistent pseudonyms are employed to maintain anonymity of a specific buyer and seller at least until an actual transaction is consummated between said specific buyer and seller.

12. A system as recited in claim 10, wherein said buyer-seller exchange application is configured to facilitate anonymous messaging between buyers and sellers.

13. A system as recited in claim 10, wherein said buyer-seller exchange application is configured to provide area maps to assist buyers in finding sellers.

14. A system as recited in claim 10, wherein said buyer-seller exchange application is configured to execute on a web server operatively coupled to said clearinghouse, and to communicate with the buyers and sellers through said clearinghouse.

15. A method for providing a marketplace for buyers and sellers of time sensitive items, comprising:
maintaining a clearinghouse that is accessible via a telecommunications network to a plurality of buyers and sellers; and
executing a buyer-seller exchange application on a computer operatively coupled to said clearinghouse, and employing said buyer-seller exchange application to sort listings of items for sale as a function of distance to the buyer.

16. A method as recited in claim 15, further comprising creating a first subscriber profile record in response to a first buyer subscribing to the clearinghouse and providing profile information for the first buyer.

17. A method as recited in claim 16, further comprising creating a second subscriber profile record in response to a first seller subscribing to the clearinghouse and providing profile information for the first seller.

18. A method as recited in claim 17, further comprising creating an offer record and record of collateral information associated with the offer record in an offer database, in response to the first seller posting an offer for sale via the buyer-seller exchange application.

19. A method as recited in claim 18, further comprising permitting the first buyer to browse the offer database.

20. A method as recited in claim 18, further comprising alerting the first buyer of an offer that meets preselected criteria in the first subscriber profile record.

21. A method as recited in claim 18, further comprising locating the first seller and communicating the first seller's location to the first buyer.

22. A method as recited in claim 18, further comprising locating the first buyer and communicating the first buyer's location to the first seller.

23. A method as recited in claim 21, wherein the first seller is located by querying a wireless carrier's Global Mobile Location Center (GMLC) or Mobile Positioning Center (MPC) for a control-plane location.

24. A method as recited in claim 22, wherein the first seller is located by querying the first seller's mobile phone.

25. A method as recited in claim 18, further comprising creating directions to guide the first buyer to the first seller.

26. A method as recited in claim 18, further comprising creating directions to guide the first seller to the first buyer.
